(19) United States
(12) Patent Application Publication
(10) Pub. No.: US 2017/0137668 A1
(43) Pub. Date: May 18, 2017

(54) INSULATING ENAMEL AND METHOD OF MAKING SAME

(71) Applicant: SCHWERING & HASSE ELEKTRODRAHT GMBH, Luegde (DE)

(72) Inventors: Roxana HAASE, Bad Pyrmont (DE); Johann REICHER, Bad Muender (DE)

(21) Appl. No.: 15/347,105

(22) Filed: Nov. 9, 2016

(30) Foreign Application Priority Data
Nov. 13, 2015 (EP) 15194534.2

(51) Int. Cl. C09D 183/04; H01B 3/30; H01F 5/06; H01B 7/02; H02K 3/30; C09D 5/24; H01B 3/42

(52) U.S. Cl. CPC C09D 183/04; C09D 5/24; H01B 3/305; H01B 3/306; H01B 3/421; H01B 7/02; H02K 3/30; H01F 5/06

(57) ABSTRACT

An electrically insulating enamel for coating wires has a base polymer of polyamide-imide, polyester-imide, polyester, polyamide, polyurethane, polyimide, polyester-amide imide, or polyepoxide modified with a long-chain polysiloxane and a short-chain polysiloxane. The long-chain polysiloxane has a number of Si units equal to 1.5 times to 2.5 times, preferably 1.7 times to 2.3 times, a number of Si units in the short-chain polysiloxane. The long-chain polysiloxane has 120 to 300 Si units, preferably 125 to 200 Si units, and particularly preferably 140 to 170 Si units. The viscosity of the enamel capable of application is 650 to 1500 mPa s.

### FIELD OF THE INVENTION

The present invention relates to an electrically insulating enamel. More particularly this invention concerns such an enamel of a modified polymer intended for insulating a conductive wire and a method of making the enamel.

### BACKGROUND OF THE INVENTION

An electrical wire is typically coated with such an enamel and used, for instance, in a coil, motor, or the like. The wire coated with the electrically insulating enamel is wound in particular during the production of the electrical components, usually by a coiling machine.

Electrically insulating enamels of the type referred to above and methods for producing such electrically insulating enamels are known in principle in the art. Reference may be made here by way of example to US 2013/0153261. The electrical wires coated with the electrically insulating enamel are advantageously wound with a high packing density of the wire or are housed in the designated electrical components. Such a packing density is desirable in particular in order to achieve an optimal induction performance. On the other hand, a high packing density substantially reduces the volume of the electrical components.

In order to achieve high packing densities a high sliding capacity of the wires is desirable. Good sliding capacities also simplify coiling of the coated wires at high speed. In this case the good sliding capacity means that the wires are less stressed mechanically or can hardly be damaged at all. In the electrically insulating enamels known in the art sliding capacity of the coated wires frequently leaves a lot to be desired. Electrically insulating enamels have already been developed, which facilitate a satisfactory sliding capacity of the coated wires (see in particular US 2013/0153261). Nevertheless there is still a further need for improvement.

### OBJECTS OF THE INVENTION

It is therefore an object of the present invention to provide an improved insulating enamel and method of making same.

Another object is the provision of such an improved insulating enamel and method of making same that overcomes the above-given disadvantages, in particular that has a high sliding capacity and also has otherwise outstanding mechanical and thermal properties.

A further object of the invention is to provide a method of making such an electrically insulating enamel.

### SUMMARY AND SPECIFIC DESCRIPTION OF THE INVENTION

An electrically insulating enamel for coating wires. The enamel has according to the invention a base polymer of polyamide-imide, polyester-imide, polyester, polyamide, polyurethane, polyimide, polyester-amide imide, or polyepoxide modified with a long-chain polysiloxane and a short-chain polysiloxane, wherein

the long-chain polysiloxane has a number of Si units equal to 1.5 times to 2.5 times, preferably 1.7 times to 2.3 times, a number of Si units in the short-chain polysiloxane,

the long-chain polysiloxane has 120 to 300 Si units, preferably 125 to 200 Si units, and particularly preferably 140 to 170 Si units,

the short-chain polysiloxane has 50 to 150 Si units, preferably 60 to 100 Si, units and particularly preferably 65 to 90 Si units, and

the viscosity of the enamel capable of application is 650 to 1500 mPa s, preferably 800 to 1350 mPa s and very preferably 850 to 1300 mPa s.

According to a particularly recommended embodiment of the invention the viscosity of the enamel capable of application is 900 to 1250 mPa s and preferably 950 to 1200 mPa s. According to a very preferred embodiment of the invention the viscosity of the enamel capable of application is between 1000 and 1150 mPa s, preferably between 1050 and 1150 mPa s, in particular 1100 or approximately 1100 mPa s. Within the scope of the invention viscosities are measured in a plate-cone viscometer at 23° C. Thus the viscosity relates to the enamel capable of application and in particular to the enamel in the form of the polymer components diluted with a solvent or solid polymer components. According to a recommended variant the solvent is N-methylpyrrolidone.

It is within the scope of the invention that the proportion of solids in the enamel capable of application is 22 to 35% by weight, preferably 23 to 33% by weight and particularly preferably 24 to 31% by weight. It is especially recommended that the solids content of the enamel ready for use is between 25 and 30% by weight, preferably between 26 and 29% by weight. A particularly worthwhile embodiment is characterized in that the viscosity of the enamel capable of application is 950 to 1200 mPa s, preferably 1000 to 1150 mPa s, very preferably 1050 to 1150 mPa s and the solids content of the enamel capable of application is 26 to 28% by weight.

The proportion of polymer components with modification units based on the entire polymer is advantageously 20 to 30% by weight, preferably 15 to 25% by weight and for example 20% by weight. A particularly recommended embodiment of the invention is characterized in that the polysiloxanes used according to the invention are polydialkylsiloxanes, preferably polydimethyl-siloxanes. In another embodiment the base polymer is modified with polymeric modifying units in the form of only two different polysiloxanes or polysiloxane chains.

It is within the scope of the invention that the number of Si units of the long-chain polysiloxane is 143 to 165. The number of Si units of the long-chain polysiloxane is preferably greater than 140, preferably greater than 143, and very preferably greater than 145. Within the scope of the invention “Si units” means in particular silicon units each having one Si atom. According to a particularly recommended variant of the electrically insulating enamel according to the invention, the number of Si units of the long-chain polysiloxane is between 145 and 160, particularly preferably between 146 and 155.

A very recommended embodiment of the invention is characterized in that the number of Si units of the short-chain polysiloxane is greater than 65 and preferably greater than 70. The number of Si units of the short-chain polysiloxane is advantageously less than 110, preferably less than 100 and preferably less than 90. A number from 70 to 80, preferably from 72 to 78 Si units has proved particularly worthwhile for the short-chain polysiloxane.

It is within the scope of the invention that the long-chain polysiloxane and/or the short-chain polysiloxane is a linear or unbranched polysiloxane. Then linear polysiloxane chains are coupled to the base polymer. The long-chain polysiloxane and/or the short-chain polysiloxane is advantageously a polydialkylsiloxane, preferably a polydimethylsiloxane. According to a very recommended embodiment of the invention the base polymer is a polyamide-imide and/or a polyester-imide. The base polymer is particularly preferably a polyamide-imide. Within the scope of the invention an embodiment has proved very worthwhile in which both the long-chain polysiloxane and also the short-chain polysiloxane are a polydialkylsiloxane, preferably a polydimethylsiloxane, and the base polymer is a polyamide-imide.

Furthermore, the object of the invention is attained by a method of making an electrically insulating enamel, in particular an electrically insulating enamel for coating wires, where at least a first monomer with at least one first functional group is reacted with at least two polysiloxanes having a different number of Si units and with in each case at least one reactive group to a polysiloxane intermediate product. The at least one first monomer with the at least one first functional group with only two polysiloxanes having different numbers of Si units and are each reacted with at least one reactive group to a polysiloxane intermediate product. The polysiloxane intermediate products are then reacted with at least one second monomer with at least one second functional group. The first monomer is first of all mixed with a first polysiloxane and then after a time period of at least 2 minutes, preferably at least 3 minutes and more preferably at least 4 minutes, with a second polysiloxane, advantageously while being stirred. In this case the two polysiloxanes differ from one another in the number of their Si units by at least 50 Si units, preferably by at least 55 Si units, preferably by at least 60 Si units, very preferably by at least 65 Si units and particularly preferably by at least 70 Si units. The base polymer chains are also preferably formed from the first monomer and the second monomer, and at least a part of these base polymer chains is modified with polysiloxane or with the polysiloxanes (polysiloxane chains). This modification of the base polymer chains is revealed in particular by the fact that the monomers reacted with the polysiloxane participate in the formation of the base polymer chains.

It is within the scope of the invention that the polysiloxanes used in the method according to the invention in each case have at least one, preferably each at least two, reactive group(s) from the groups: hydroxy group (—OH), carboxyl group (—COOH), amine group (—NH₂). In this case the hydroxy group (—OH) is particularly preferred. It is recommended that each polysiloxane has two reactive groups. A reactive group, preferably a reactive group from the aforementioned selection is preferably bonded to each chain end of the two chain ends of a polysiloxane or each polysiloxane. It is recommended that the two reactive groups of a polysiloxane are identical and it has proved particularly worthwhile that all reactive groups at the chain ends of the polysiloxanes or of the two polysiloxanes identical.

It is within the scope of the invention that the polysiloxanes are bonded to the base polymer via their reactive groups or via their reactive end groups. Advantageously the long-chain polysiloxane and/or the short-chain polysiloxane is formed as a linear, unbranched polysiloxane, and a reactive group, preferably a reactive group from the aforementioned selection, is preferably bonded to each chain end of the long-chain polysiloxane and/or the short-chain polysiloxane.

According to one embodiment, which is particularly important within the scope of the invention, the hydroxy group is formed as a hydroxy alkyl group (—R—OH) or particularly preferably as a hydroxyalkoxy group (—R—O—R—OH), where R represents an alkyl radical. It is recommended that the long-chain polysiloxane and/or the short-chain polysiloxane has in each case two hydroxy groups, preferably hydroxyalkoxy groups. It is within the scope of the invention that the long-chain polysiloxane and/or the short-chain polysiloxane is formed as a linear unbranched polysiloxane and that a hydroxy group, preferably a hydroxyalkoxy group, as reactive group is bonded to each chain end of the polysiloxane. A particularly recommended embodiment the invention is characterized in that the long-chain polysiloxane and/or the short-chain polysiloxane in each case have identical reactive groups at their chain ends and that preferably two identical hydroxyalkoxy groups as reactive groups are bonded to both chain ends of a linear unbranched polysiloxane.

Furthermore, it is within the scope of the invention that first of all the first monomer is mixed with one of the two polysiloxanes, preferably with the short-chain polysiloxane. It is recommended that in this case the first monomer is dissolved in at least one solvent. The first monomer is preferably provided with two first functional groups. According to a worthwhile embodiment the first monomer is a diisocyanate, preferably an aromatic diisocyanate and particularly preferably methylene diphenyl isocyanate (MDI). The first monomer or the diisocyanate or the MDI is preferably dissolved in N-methylpyrrolidone (NMP) as solvent. The solution of the diisocyanate or of the MDI in the at least one solvent is preferably maintained at a temperature of 30 to 45° C., preferably at a temperature of 35 to 45° C. In this case the temperature of 45° C. is advantageously not exceeded.

Then a polysiloxane, preferred the short-chain polysiloxane, is added. It is within the scope of the invention that the first monomer by comparison with the polysiloxane or by comparison with the short-chain polysiloxane is presented or added in excess. It is recommended that the quantity of substance (in moles) of the first monomer is at least the 50 times, preferably at least 80 times, very preferably at least 90 times and particularly preferably at least 100 times the quantity of substance (in moles) of the polysiloxane or of the short-chain polysiloxane. It is recommended that the quantity of substance (in moles) of the first monomer is a maximum of 200 times, preferably a maximum of 170 times, and particularly preferably a maximum of 150 times the quantity of substance (in moles) of the polysiloxane or of the short-chain polysiloxane. The polysiloxane or the short-chain polysiloxane is advantageously first of all in a solvent, in particular in a non-polar solvent, for example in xylol. Then this solution of the polysiloxane/short-chain polysiloxane is added to the solution of the first monomer, preferably to the solution of MDI.

It is within the scope of the invention that after the mixing of the first monomer with the first polysiloxane the resulting mixture is mixed with the second polysiloxane, preferably with the comprising the long-chain polysiloxane. According to a particularly recommended embodiment the first monomer (or the initial quantity of the first monomer before mixing with the first polysiloxane) is present in excess with respect to this second polysiloxane. It is recommended that the quantity of substance (in moles) of the initially added first monomer (initial quantity of the first monomer) is at least 100 times, preferably at least 150 times, very preferably at least 180 times and particularly preferably at least 200 times the quantity of substance (in moles) of the second polysiloxane. It is recommended that the quantity of substance (in moles) of the first monomer is a maximum of 350 times, preferably a maximum of 300 times, and particularly preferably a maximum of 280 times the quantity of substance (in moles) of the second polysiloxane. The second polysiloxane, preferably the long-chain polysiloxane, is advantageously first of all dissolved in a solvent, in particular in a non-polar solvent, for example in xylol, and added to the mixture in this form.

It is recommended that the mass ratio of the two polysiloxanes relative to one another is 40:60 to 60:40 and preferably 50:50 or approximately 50:50. After the addition of the two polysiloxanes or the solutions of the two polysiloxanes the entire mixture is heated to a temperature of 50 to 80° C., preferably to a temperature of 60 to 75° C. and particularly preferably to a temperature between 65 and 70° C., for example to a temperature of 70° C. The entire mixture is advantageously by kept at said temperature, in particular at 70° C., over a time period from 30 minutes to 90 minutes, preferably over a time period from 40 minutes to 80 minutes and particularly preferably over a time period from 50 minutes to 70 minutes, for example over a time period of 60 minutes. During this the mixture is advantageously stirred. It is recommended that heating the second monomer is added to the mixture only after this heating. The ratio of the quantity of substance (in moles) of the employed second monomer to the quantity of substance of the (originally employed) first polysiloxane or to the quantity of substance of the (originally employed) second polysiloxane corresponds to the above-specified ratio of the quantity of substance of the first monomer to quantity of substance of the first polysiloxane or second polysiloxane. It is recommended to use a second monomer with two second functional groups. According to a worthwhile embodiment a tricarboxylic acid anhydride is employed as the second monomer and according to a particularly recommended embodiment trimellitic acid anhydride (TMA) is employed. In principle it is also within the scope of the invention that in the procedure described above the tricarboxylic acid anhydride, in particular the trimellitic acid anhydride (TMA), is employed as the first monomer and that the diisocyanate or the aromatic diisocyanate, in particular the methylene diphenyl isocyanate (MDI) is employed as the second monomer.

Advantageously, after the addition of the second monomer the mixture continues to be kept at the aforesaid temperature, in particular at 70° C., over a time period from 30 minutes to 90 minutes, preferably over a time period from 40 minutes to 80 minutes and particularly preferably over a time period from 50 minutes to 70 minutes. During this the mixture is preferably stirred. According to a worthwhile embodiment, following this the temperature of the mixture is preferably heated to a higher temperature, namely preferably to a temperature between 80° C. and 115° C., preferably to a temperature between 90° C. and 110° C., more preferably to a temperature between 95° c. and 105° c., for example to 100° C. It is recommended that the mixture is maintained at said temperature for a time period from 30 minutes to 90 minutes, very preferably for a time period from 40 to 80 minutes and particularly preferably for a time period from 50 to 70 minutes, for example for a time period of 60 minutes.

It is recommended that after the addition of the second monomer and preferably after the previously described thermal treatment or after the previously described thermal treatments the mixture is heated (further) to a temperature between 110 to 120° C., in particular is heated to a temperature of 115° C. or approximately 115° C./ The mixture is preferably maintained at the aforementioned temperature over a time period of at least 90 minutes and particularly preferably at least 100 minutes. According to a particularly recommended embodiment the mixture is maintained at said temperature for a time period from 100 to 140 minutes, for example for a time period of 120 minutes or approximately 120 minutes. The mixture is advantageously maintained at this increased temperature until, when a diisocyanate is employed as the monomer or as the first monomer, isocyanate is no longer, in particular an isocyanate band in the IR spectrum is no longer detectable. Following this the mixture is preferably heated to an even higher temperature, and it is recommended that it is heated to a temperature between 115 and 145° C., preferably between 120 and 140° C., in particular to a temperature of 130° C. or approximately 130° C. It is within the scope of the invention that the mixture is maintained at this temperature, preferably maintained at this temperature while being stirred, until the mixture in the cooled state has a viscosity of 25,000 to 45,000 mPa s, preferably from 30,000 to 40,000 mPa s and very preferably from 32,000 to 38,000 mPa s. The aforementioned viscosity is measured in particular at a temperature of 30° C. (cooled state).

It is within the scope of the invention that, following this, the mixture is diluted to the enamel that is capable of application or electrically insulating enamel, so that the enamel has the viscosity according to the invention. The dilution preferably takes place with N-methylpyrrolidone (NMP). When the enamel according to the invention is applied to an object, in particular on a conductive wire, firing of the enamel takes place, preferably at a firing temperature of 400 to 850° C. and particularly preferably at a firing temperature of 450 to 800° C. In the applied or fired state the enamel according to the invention is not transparent and matt.

The invention further relates to a wire or a conductive wire which is coated with an electrically insulating enamel according to the invention. It is within the scope of the invention that the conductive or electrically conductive wire is a metal wire. According to a particularly recommended embodiment the metal wire is a copper wire. The wire according to the invention preferably consists of copper or substantially of copper and/or of aluminum or substantially of aluminum. Furthermore, it is within the scope of the invention that the electrically insulating enamel according to the invention forms the outer layer of the coating of the wire. Advantageously at least one enamel layer is already present on the wire and the electrically insulating enamel according to the invention is then applied to this at least one lacquer layer. It is within the scope of the invention that the electrically insulating enamel according to the invention is subjected to a firing process after application. The process is advantageously operated with firing temperatures between 400 and 850° C., preferably 450 to 800° C.

The invention also relates to an assembly, in particular a coil, an electric motor or the like comprising a wire according to the invention or a comprising a wire coated according to the invention. As is usual, a plurality of windings of the wire according to the invention is applied to a coil. Because of the properties of the electrically insulating enamel according to the invention or of a wire coated therewith a surprisingly high packing density of the wire can be achieved.

It is within the scope of the invention that the electrically insulating enamel coating of this wire has no additional lubricant or no “external” lubricant. Thus the electrically insulating enamel is designed to be lubricant-free. Sliding characteristics are provided here according to the invention merely by the base polymer chains modified with the polysiloxane. According to a particularly preferred embodiment of the invention, a wire coated with the electrically insulating enamel according to the invention is completely lubricant-free, at least externally or on its external surface.

The invention is based on the discovery that a surprisingly high sliding capacity of the coated wire can be achieved with the electrically insulating enamel according to the invention. By comparison with conventional enamel coatings of wires, the enamel coating according to the invention is characterized by a considerable reduction of the frictional resistance of the coating. Furthermore, the invention is based on the knowledge that during curing of the enamel according to the invention a self-structuring of the surface of the enamel takes place, since the modifying units according to the invention are incompatible with the base polymer. Therefore a phase separation is produced on the surface of the electrically insulating enamel and the phase separation causes the outstanding sliding capacity of the enamel coating or of the wire. By comparison with the electrically insulating enamels known hitherto from the prior art or the wires coated therewith, the invention is characterized by a further surprisingly substantial improvement of its sliding characteristics. For this success according to the invention, on the one hand the use according to the invention of the two polysiloxanes of different chain length and also, on the other hand, the viscosity or the solids content of the enamel which is capable of application, are critical. In particular, the viscosity of the enamel capable of application which is set according to the invention, in combination with the use of the two different polysiloxanes, brings about a particularly advantageous phase separation on the surfaces. Furthermore, it should be emphasized that at the same time the thermal properties of the electrically insulating enamel according to the invention meet all requirements and the enamel coatings according to the invention have, in particular, a high temperature resistance. Furthermore, they are surprisingly mechanically resistant and also have a high flexibility. Because of the surprisingly high sliding capacity of the electrically insulating enamel, the wires coated with the enamel can be wound without problems at high speeds and in particular can also be wound automatically by coiling machines. With the wires coated according to the invention a surprisingly high packing density can be achieved during coiling of the wire, and as a result optimal induction characteristics as well as an advantageous volume reduction can be attained. It should also be emphasized that the method according to the invention operates with simple and cost-effective measures.

It has already been demonstrated above that according to a particularly recommended embodiment of the invention an electrically insulating enamel on the basis of polyamide-imide is provided. Thus in this case the base polymer is formed by polyamide-imide and this polyamide-imide is modified with polymeric modifying units in the form of at least two or in the form of two different polysiloxane chains. It is then within the scope of the invention that a diisocyanate or methylene diphenyl isocyanate (MDI) and a tricarboxylic acid anhydride or trimellitic acid anhydride (TMA) are employed as monomers in the method of production.

It is recommended that in each case linear unbranched polysiloxanes are employed as long-chain polysiloxane and as short-chain polysiloxanes, and these polysiloxanes preferably have a reactive group at each of their two chain ends. The reactive groups of a polysiloxane and preferably of both polysiloxanes according to a recommended embodiment of the invention. A very worthwhile embodiment of the invention is characterized in that the reactive group is present in the form of a hydroxy group and particularly preferably in the form of a hydroxyalkoxy group (—R₁—O—R₂—OH). It is recommended that all reactive groups of the long-chain polysiloxane and of the short-chain polysiloxane are formed as hydroxyalkoxy groups. A polysiloxane structure which is especially preferred within the scope of the invention is as follows:

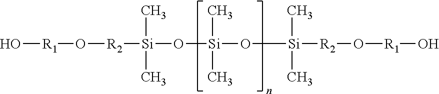

Thus this polysiloxane structure has a hydroxyalkoxy group on each chain end. R₁ and R₂ here respectively represent an alkyl group or alkylene group. In this case R₁ and R₂ may be identical or may also be different from one another. Such a polysiloxane with this polysiloxane structure is preferably employed both for the long-chain polysiloxane and also for the short-chain polysiloxane. n is specified in greater detail below. A particularly recommended polysiloxane structure within the scope of the invention has the following structure:

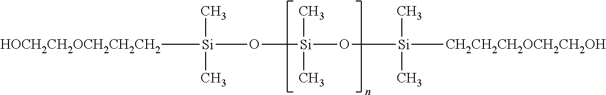

It is recommended that this polysiloxane structure is employed both for the longer-chained and also for the short-chain polysiloxane.

This is α,ω-hydroxy-terminated polydialkylsiloxane. In this case for the long-chain polysiloxane n is between 125 and 175, preferably between 130 and 170 and very preferably between 140 and 170. Furthermore, for the short-chain polysiloxane n is preferably between 50 and 100, preferably between 60 and 90 and particularly preferably between 70 and 80. n is the number of silicon units or the number of Si units.

We claim:

1. An electrically insulating enamel for coating wires, the enamel comprising a base polymer of polyamide-imide, polyester-imide, polyester, polyamide, polyurethane, polyimide, polyester-amide imide, or polyepoxide modified with a long-chain polysiloxane and a short-chain polysiloxane, wherein
the long-chain polysiloxane has 120 to 300 Si units,
the short-chain polysiloxane has 50 to 150 Si units, and
the viscosity of the enamel capable of application is 650 to 1500 mPa s.

2. The electrically insulating enamel defined in claim 1, wherein a proportion of solids in the enamel is 22 to 35% by weight.

3. The electrically insulating enamel defined in claim 1, wherein a proportion of the polysiloxanes in the modified base polymer is 10 to 30% by weight.

4. The electrically insulating enamel defined in claim 1, wherein the long-chain polysiloxane or the short-chain polysiloxane is a linear or unbranched polysiloxane.

5. The electrically insulating enamel defined in claim 1, the base polymer is a polyamide-imide or a polyester-imide.

6. A method of making an electrically insulating enamel for coating wire, the method comprising the steps of:
mixing a first monomer having at least one first functional group with a first polysiloxane for at least two minutes to form a polysiloxane intermediate product;
mixing the polysiloxane intermediate product with a second polysiloxane with a second functional group, one of the polysiloxanes being a long-chain polysiloxane at least 50 Si units more than the other of the polysiloxanes that is a short-chain polysiloxane, thereby forming from the first and second monomers base polymer chains at least some of which are modified with at least one of the polysiloxanes.

7. The method defined in claim 6, wherein the polysiloxanes each have at least one reactive group comprises of a hydroxy group (—OH), a carboxyl group (—COOH), or an amine group (—NH₂).

8. The method defined in claim 6, wherein the first monomer is added in excess such that a quantity of the first monomer in moles is at least the 50 times a quantity of the first monomer of the short-chain polysiloxane.

9. The method defined in claim 6, further comprising the step, after mixing the first monomer with the first polysiloxane, of:
mixing the resulting polysiloxane intermediate group the second polysiloxane, the first monomer being present in excess with respect to the second polysiloxane with the molar quantity first monomer being at least 100 times the molar quantity of the first monomer in the second long-chain polysiloxane.

10. The method defined in claim 6, wherein at least one of the polysiloxanes is employed in the form of a solution in a non-polar solvent.

11. The method defined in claim 6, further comprising the step, after addition of the second monomer, of:
maintaining the entire mixture at a temperature of 110 to 120° C. over a time period of at least 90 min.

12. The method defined in claim 6, further comprising the step, after the addition of the second monomer, of:
maintaining the reaction mixture at an increased temperature between 110 and 120° C. until the first functional group of the first monomer is no longer detectable.

13. The method defined in claim 12, further comprising the step, after addition of the second monomer, of:
maintaining the entire reaction mixture at an increased temperature between 110 and 120° C. until, when a diisocyanate is employed as the first monomer, isocyanate is no longer detectable by an isocyanate band in the IR spectrum.

14. The method defined in claim 6, further comprising the step, after addition of the second monomer, of:
maintaining the mixture at a temperature of 125 to 135° C. until the mixture when cooled has a viscosity of 25,000 to 45,000 mPa s.

15. A conductive wire coated with an electrically insulating enamel according to claim 1.

16. A coil comprising a wire or comprising a conductive wire according to claim 18.

17. The enamel defined in claim 1, wherein the long-chain polysiloxane has 1.7 to 2.3 times as many Si units as the short-chain polysiloxane.

18. The enamel defined in claim 1 wherein the long-chain polysiloxane has 140 to 170 Si units and the short-chain polysiloxane has 60 to 100 Si units.

19. The enamel defined in claim 1, wherein the short-chain polysiloxane has 65 to 90 Si units.

20. The electrically insulating enamel defined in claim 1, wherein the long-chain polysiloxane has 143 to 165 Si units.

21. The electrically insulating enamel defined in claim 1, wherein the long-chain polysiloxane has more than 145 Si units.

22. The electrically insulating enamel defined in claim 1, wherein the short-chain polysiloxane has more than 65 Si units.

23. The electrically insulating enamel defined in claim 1, wherein the short-chain polysiloxane has more than 70 Si units.

24. The enamel defined in claim 1, wherein the viscosity of the enamel being 800 to 1350 mPa s.

25. The enamel defined in claim 1, wherein the viscosity of the enamel being 850 to 1300 mPa s.

26. The enamel defined in claim 1, wherein the viscosity of the enamel is 900 to 1250 mPa s.

27. The enamel defined in claim 1 wherein the viscosity of the enamel is 950 to 1200 mPa s.

28. The electrically insulating enamel defined in claim 1, wherein a proportion of solids in the enamel is 23 to 33% by weight.

29. The electrically insulating enamel defined in claim 1, wherein a proportion of solids in the enamel is 24 to 31% by weight.

30. The electrically insulating enamel defined in claim 1 wherein a proportion of the polysiloxanes in the modified base polymer is 15 to 25% by weight.
